(19) United States
(12) Patent Application Publication
(10) Pub. No.: US 2021/0373368 A1
(43) Pub. Date: Dec. 2, 2021

(54) DISPLAY DEVICE

(71) Applicant: TCL CHINA STAR OPTOELECTRONICS TECHNOLGY CO., LTD., SHENZHEN, GUANGDONG (CN)

(72) Inventor: Huanhsun TUNG, Shenzhen, Guangdong (CN)

(21) Appl. No.: 16/969,639

(22) PCT Filed: Jul. 9, 2020
(86) PCT No.: PCT/CN2020/101032

§ 371 Date: Aug. 13, 2020

(30) Foreign Application Priority Data
Jun. 2, 2020 (CN) 2020104883930

(51) Int. Cl. G02F 1/1347; G02F 1/1335; G02F 1/1345

(52) U.S. Cl. CPC G02F 1/1347; G02F 1/133514; G02F 1/1345; G02F 1/133531

(57) ABSTRACT

The present invention provides a display device having a display area and a frame area surrounding the display area, and includes a first display panel comprising a plurality of first pixel units arranged in an array, wherein the first pixel units are distributed in the display area and extend to the frame area, and the first pixel units at an edge of the display area extend to the frame area; and a second display panel disposed above the first display panel, wherein the second display panel comprises a plurality of second pixel units arranged in an array, and the second pixel units correspond to the first pixel units.

### FIELD OF INVENTION

The present application relates to a field of display technology, and more particularly to a display device.

### BACKGROUND

A liquid crystal display device is a display device that uses a liquid crystal composition for displaying. A representative display method of the liquid crystal display device is that the liquid crystal composition sealed between a pair of substrates is irradiated with light from a backlight and a voltage is applied to the liquid crystal composition to change an orientation of liquid crystal molecules, thereby controlling an amount of the light transmitted through the liquid crystal display device. Such a liquid crystal display device has advantages of thin body, light weight, and low power consumption, and therefore can be used in electronic devices such as smart phones, tablet personal computers (PCs), and car navigation systems.

In a dual-laminating liquid crystal display device, the highest precision of an existing laminating device is only 200 um, which is much smaller than a pixel density in the liquid crystal display device. A sub-pixel width of ultra-high definition (UHD) device is 124 um, and a sub-pixel width of full-high definition (FHD) device is 248 um, so if dual cells of a 65″ UHD device and a 65″ FHD device are laminated together, a maximum possible deviation is greater than one sub-pixel width of the 65 UHD device, which will cause a relative deviation of a first pixel and a second pixel during lamination, thereby causing color deviation in a display frame area of the liquid crystal display device.

### Technical Problem

The present application provides a display device to solve technical problems of color deviation caused by pixel misalignments in a dual display panel in the prior art.

### Technical Solution

The present application provides a display device having a display area and a frame area surrounding the display area, comprising: a first display panel comprising a plurality of first pixel units arranged in an array, wherein the first pixel units are distributed in the display area and extend to the frame area, and the first pixel units at an edge of the display area extend to the frame area; and a second display panel disposed above the first display panel, wherein the second display panel comprising a plurality of second pixel units arranged in an array, and the second pixel units correspond to the first pixel units.

Furthermore, the first display panel comprises: a first glass substrate disposed in the display area and the frame area; a first liquid crystal layer disposed on the first glass substrate; and a second glass substrate disposed on a side of the first pixel unit away from the first liquid crystal layer. The second display panel comprises: a third glass substrate disposed on a side of the second glass substrate away from the first liquid crystal layer; a second liquid crystal layer disposed on a side of the third glass substrate away from the first pixel unit; a color resist layer disposed on a side of the second liquid crystal layer away from the third glass substrate; and a fourth glass substrate disposed on a side of the color resist layer away from the second liquid crystal layer.

Furthermore, the display device further comprises a backlight disposed on a side of the first glass substrate away from the first liquid crystal layer.

Furthermore, the first liquid crystal layer comprises a first polarizer disposed on the first glass substrate; a first liquid crystal cell evenly disposed on a side of the first polarizer away from the first glass substrate; and a first analyzer disposed on a side of the first liquid crystal cell away from the first polarizer. The second liquid crystal layer comprises a second polarizer disposed on the second glass substrate; a second liquid crystal cell evenly disposed on a side of the second polarizer away from the second glass substrate; and a second analyzer disposed on a side of the second liquid crystal cell away from the second polarizer, wherein a light-transmitting axis-direction of the first polarizer is perpendicular to a light-transmitting axis-direction of the first analyzer, and a light-transmitting axis-direction of the first analyzer is parallel with a light-transmitting axis-direction of the second polarizer, and the light-transmitting axis-direction of the second polarizer is perpendicular to the light-transmitting axis-direction of the second analyzer.

Furthermore, a ratio of a width of the first pixel unit extending out of the display area to a width of the first pixel unit is 1.5:1.

Furthermore, the display device further comprises a plurality of source driving chips disposed in the frame area; and a plurality of electrode traces connecting the pixel units and the source driving chips, wherein the pixel units in the same column direction are connected to the corresponding source driving chip through the same electrode trace.

Furthermore, the source driving chips comprises a first source driving chip and a second source driving chip disposed on both sides of a circuit board, and a plurality of third source driver chips disposed between the first source driving chip and the second source driver chip; the first source driving chip and the second source driving chip use 322 channels; and the third source driving chips use 320 channels.

Furthermore, the second pixel units comprise at least one color of red, blue, and green, and the second pixel units are arranged with an interval when the second pixel units comprise more than one color.

Furthermore, a width of the first pixel unit on the outermost side of the first display panel is half of a width of the first pixel units in the display area.

### Advantageous Effects

Image identification extraction devices, and brightness adjusting methods and devices for logo provided by the present application extract logos through increasing numbers of key frames in a process of extracting logos and using video-frame weighting to improve an accuracy of the logo extraction. In addition, according to the brightness of background areas (of the video image) near the logo, the brightness of the logo can be adjusted in real time, so that the brightness of the logo matches or is equivalent to the brightness of the video image, thereby effectively suppressing an afterimage phenomenon.

Beneficial effects of the present invention are that the display device of the present invention can improve a display quality of the display device by laminating a first display panel and a second display panel. Since a second pixel unit is laminated from a middle position of a first pixel unit and gradually extends to an edge of the first pixel unit, the first display panel and the second display panel cannot be accurately laminated due to an accuracy problem of the laminating device. Hence, the first pixel unit is extended to a frame area and the second pixel unit is also partially extended to the frame area at the same time, and a normal display of a display area will not be affected even if the first pixel unit and the second pixel unit at an edge have misalignment, which can effectively prevent color deviation due to laminating misalignment caused by laminating the first pixel unit and the second pixel unit at the edge of the display area of the display device.

### BRIEF DESCRIPTION OF DRAWINGS

To detailly explain the technical schemes of the embodiments or existing techniques, drawings that are used to illustrate the embodiments or existing techniques are provided. Apparently, the illustrated embodiments are just a part of those of the present disclosure. It is easy for any person having ordinary skill in the art to obtain other drawings without labor for inventiveness.

FIG. 1 is a schematic diagram of a positional relationship between a first display panel and a second display panel in an embodiment.

FIG. 2 is a schematic diagram of a first display panel in an embodiment.

FIG. 3 is a schematic diagram of a moving direction of a second pixel unit in the embodiment.

FIG. 4 is a connection diagram of a first pixel unit and a source driving chip in an embodiment.

FIGS. 5-6 are schematic diagrams of a display device in an embodiment.

In the figures:
101 display area; 102 frame area;
110 first display panel; 120 second display panel;
130 source driving chip; 140 electrode trace;
150 circuit board; 111 first pixel unit;
121 second pixel unit; 11101 first polarizer;
11102 first glass substrate; 11103 first liquid crystal cell;
11104 second glass substrate; 11105 first analyzer;
160 backlight; 12101 second polarizer;
12102 third glass substrate; 12103 second liquid crystal cell;
12104 color resist layer; 12105 fourth glass substrate;
12106 second analyzer.

### DETAILED DESCRIPTION

The technical solutions in the embodiments of the present application will be described clearly and completely with reference to the drawings in the embodiments of the present application. Obviously, the described embodiments are only a part of the embodiments of the present application, but not all the embodiments. Based on the embodiments in the present application, all other embodiments obtained by those skilled in the art without making creative work fall within the protection scope of the present application.

In the description of this application, it should be understood that the terms “vertical”, “horizontal”, “length”, “width”, “upper”, “lower”, “front”, “rear”, “left”, “right”, “perpendicular”, “level”, “top”, “bottom”, “inner”, “outer”, “clockwise”, “counterclockwise”, etc. indicated orientation or positional relationship is based on the orientation or positional relationship shown in the drawings, only to facilitate the description of this application and simplify the description, not to indicate or imply the device referred to or the element must have a specific orientation, be constructed and operated in a specific orientation, and therefore cannot be understood as a limitation of the present application.

### EMBODIMENTS

In the present embodiment, a display device of the invention comprises a display area 101 and a frame area 102 surrounding the display area 101.

The display device further comprises a first display panel 110, a second display panel 120, a source driving chip 130, electrode traces 140, a circuit board 150, and a backlight 160.

As shown in FIG. 2, FIG. 2 is a schematic diagram of the first display panel in an embodiment. Specifically, the first display panel 110 is disposed with a plurality of first pixel units 111, and the first display panel 110 comprises a first polarizer 11101, a first glass substrate 11102, a first liquid crystal cell 11103, a second glass substrate 11104, and a first analyzer 11105.

The first polarizer 11101 is disposed on a side of the backlight 160. The first polarizer 11101 can absorb light parallel to its arrangement direction, and only allows light in the vertical direction to pass through the first polarizer 11101.

The first glass substrate 11102 is disposed on a side of the first polarizer 11101 away from the backlight 160. The first glass substrate 11102 is a light-transmitting glass substrate, so that light passing through the first polarizer 11101 is directly irradiated on the first liquid crystal cell 11103, thereby achieving the purpose of supporting the first liquid crystal unit 11103 without affecting a light emitting efficiency of the first pixel unit 111.

The first liquid crystal cell 11103 is disposed on a side of the first glass substrate 11102 away from the first polarizer 11101, and a light passing direction of the first analyzer 11105 is perpendicular to a light passing direction of the first polarizer 11101. When there is no electric field above and below the first liquid crystal cell 11103, liquid crystal molecules in the first liquid crystal cell 11103 are parallel to a rubbing direction of the first polarizer 11101, and light cannot pass through the first analyzer 11105 and the display unit does not display any image at this time.

When an electric field is applied above and below the first liquid crystal cell 11103, the liquid crystal molecules in the first liquid crystal cell 11103 are perpendicular to the rubbing direction of the first polarizer 11101, that is, the light is parallel with the direction of the light-passing direction of the first analyzer 11105 and the display unit displays white light at this time.

A conversion speed and twist angle of liquid crystal molecules are determined by a magnitude of the voltage applied to the first liquid crystal cell 11103. Therefore, the first pixel unit 111 can display all black, all white, or gray levels between all black and all white.

The second display panel 120 is a color display panel, which can make the display device 10 display a color image.

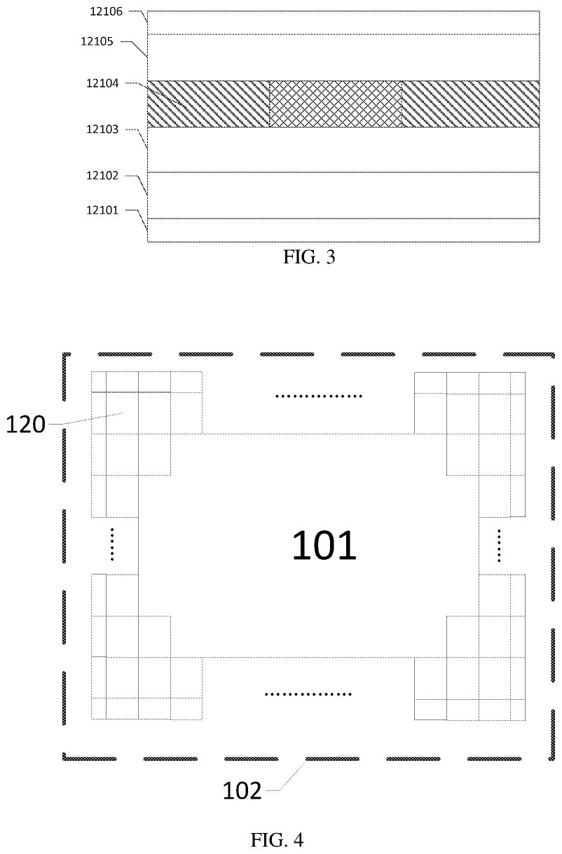

As shown in FIG. 3, FIG. 3 is a schematic diagram of the second display panel in an embodiment. Specifically, the second display panel 120 is disposed with a plurality of pixel units 121. The second display panel 120 comprises a second polarizer 12101, a third glass substrate 12102, a second liquid crystal unit 12103, a color resist layer 12104, a fourth glass substrate 12105, and a second analyzer 12106.

The second polarizer 12101 is disposed on a side of the first analyzer 11105 away from the second glass substrate 11104. In order to ensure that the light emitted from the first display panel 110 can maximally enter the second display panel 120, a light-passing direction of the second polarizer 12101 is consistent with the light-passing direction of the first analyzer 11105.

The third glass substrate 12102 is disposed on a side of the second polarizer 12101 away from the first analyzer 11105. A material of the third glass substrate 12102 is the same as a material of the first glass substrate 11102.

The second liquid crystal cell 12103 is disposed on a side of the third glass substrate 12102 away from the second polarizer 12101, a light-passing direction of the second polarizer 12101 is vertical to a light-passing direction of the second analyzer 12106. When there is no electric field applied above and below the second liquid crystal cell 12103, liquid crystal molecules in the second liquid crystal cell 12103 are parallel to a rubbing direction of the second polarizer 12101 and light cannot pass through the second analyzer 12106. The display unit does not display any image at this time.

The color resist layer 12104 is disposed on a side of the second liquid crystal unit 12103 away from the third glass substrate 12102. The color resist layer 12104 comprises sub-pixels of three colors comprising blue sub-pixel, green sub-pixel, and red sub-pixel. In this embodiment, the pixel unit 121 comprises color resist layers 12104 of three different colors arranged horizontally, and since the pixel unit 121 comprises pixels composed of three primary colors, each pixel unit 121 can display an image of any of the three primary colors.

When an electric field is applied above and below the second liquid crystal cell 12103, liquid crystal molecules in the second liquid crystal cell 12103 are perpendicular to the rubbing direction of the second polarizer 12101, that is, light is parallel with the light-passing direction of the second analyzer 12106, and the second display panel 120 can display color pictures due to the presence of sub-pixels.

By adjusting a magnitude of voltage applied to the first display panel 110 and the second display panel 120, a brightness and color contrast of the display device 10 can be controlled, and a display quality of the display device 10 can be improved.

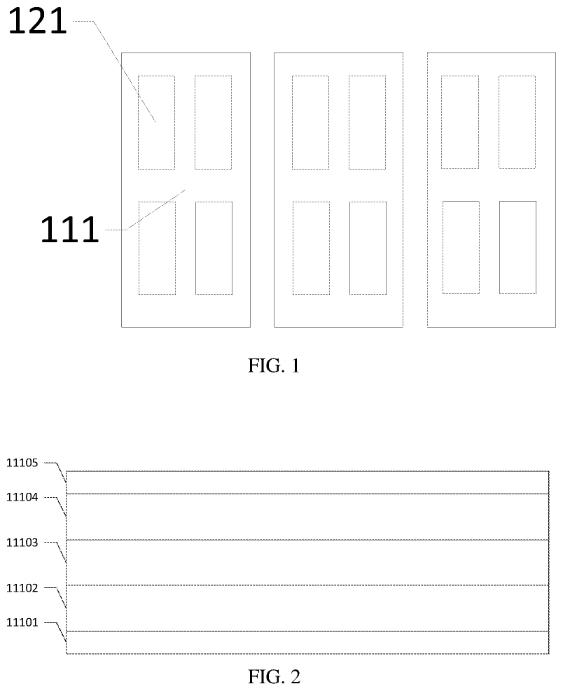

As shown in FIG. 1, the first display panel 110 of this embodiment is not disposed with a display panel, so the first display panel 110 displays only black-and-white gray screens. On the one hand, manufacturing cost of the display device 10 is saved, and on the other hand, a light-transmitting rate of the first display panel 110 is also improved. When a resolution of the first display panel 110 is 1920 by 1080, the light-transmitting rate of the first display panel 110 can be increased by 108%. When the resolution of the first display panel 110 is 1280 by 720 or 960 by 540, the light-transmitting rate of the first display panel 110 can be increased by 105%.

In this embodiment, the display device 10 is a single-sided display device, that is, a gray-scale image of the first pixel unit 111 and a color image of the second pixel unit 121 overlap to form a display image of the display device 10. Due to a laminating accuracy problem, the first pixel unit 111 and the second pixel unit 121 are easily misaligned, thereby forming a color deviation problem at the four edges of the display device 10.

As shown in FIG. 4, a distance of the first pixel unit 111 beyond the display area 101 is 1.5 times of a width of the first pixel unit 111, and the first pixel unit 111 beyond the display area 101 does not act as a pixel of the display image of the display device 10 but is mainly used to prevent the color deviation formed at edges of the display area 101 of the display device 10.

The second display panel 120 may use active matrix circuits to connect source driving chips 130 to realize self-luminous light and display effects of the display device. By adjusting a brightness of the second pixel unit 121 itself, a gray-scale display of the second display panel 120 can be realized to improve a resolution of the display device 10.

The first display panel 110 may use a passive matrix circuit and does not use the source driving chips 130, so purposes of large aperture ratio and high resolution can be achieved.

In this embodiment, a size of the first pixel unit 111 is 248 μm by 744 μm, and a size of the second pixel unit 121 is 124 μm by 372 μm. Ideally, one first pixel unit 111 can laminate with four second pixel units 121, but because an accuracy of a current laminating equipment can only reach 200 μm, which does not allow the second pixel units 121 to be accurately laminated with the first pixel unit 111, an error can be up to a width of a second pixel unit 121. Influence of this error is most easily reflected at edges of the first display panel 110 and the second display panel 120.

In order to prevent this phenomenon, in this embodiment, the second pixel unit 121 is extended out of the display area 101, and the second pixel unit 121 may be laminated from one end of the first display panel 110 to the other end. As shown in FIG. 5, it may also be attached from a middle position of the first display panel 110 to both ends. Since the first display panel 110 exceeds the display area 101 by a distance of about 1.5 times of the width of the first pixel units 111, this distance of 1.5 times of the width of first pixel units 111 exceeds the maximum error of the current laminating device, thereby ensuring that any of the second pixel units 121 in the display area 101 are laminated with the first pixel unit 111, thereby effectively preventing the misalignment problem of the second pixel unit 121 and the first pixel unit 111 in the display area 101, and improving display quality of the display device 10.

In order to achieve the goal of the first pixel unit 111 extending toward the frame area 102, in this embodiment, a plurality of sets of source driving chips 130 are used to connect to the first pixel units 111. Specifically, the source driving chips 130 are disposed in the frame area 102, and the source driving chips 130 are connected to the first pixel units 111 through the electrode traces 140. The first pixel units 111 in the same column are connected to the corresponding source driving chip 130 through the same electrode trace 140.

Any one of the source driving chips 130 is provided with a plurality of pins, and the first pixel units 111 in the same column is connected to the corresponding pins through the same electrode trace 140. Particularly, a channel of the source driving chips 130 on both sides of the display area 101 is different from a channel of the source driving chips 130 in the middle of the display area 101. The source driving chips 130 on both sides of the display area 101 use 322 channels and the source driving chips 130 in the middle of the display area 101 uses 320 channels. Since the source driving chips 130 on both sides of the display area 101 use 322 channels, the pins thereon are more than the pins of the source driving chips 130 in the display area 101, and more first pixel units 111 can be connected, thereby ensuring that the first display panel 110 can extend into the frame area 102.

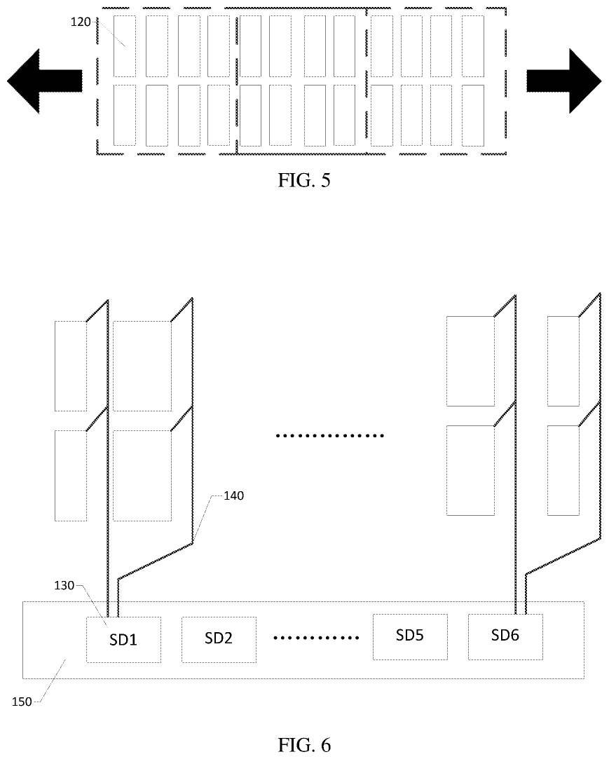

As shown in FIG. 6, in this embodiment, the source driving chips disposed on both sides of the display area 101 are SD1 and SD6, and the source driving chips disposed in the middle of the display area 101 are SD2, SD3, SD4, and SD5.

Wherein, the SD1 and SD6 use 322 channels, which can be connected with 1924 conductive traces, and a width of the first pixel unit connected by the conductive traces on the most edge side of the display area 101 is half of a width of the first pixel unit close to the inner side the display area 101. Particularly, the width and height of the first pixel units located at the four corners of the first display panel 110 are both one-half of the first pixel units closer to the inner side of the display area.

Taking the size of the first pixel unit in this embodiment as an example, in this embodiment, the size of the first pixel unit 111 is 744 μm by744 μm, and the size of the first pixel unit away from the display area 101 in the column direction is 372 μm by 744 μm.

In the row direction, the size of the farthest first pixel unit 111 away from the display area 101 is 744 μm by 372 μm.

At four corners of the first display panel 110, the size of the first pixel units 111 is 372 μm by 372 μm.

The display device of the present invention can improve a display quality of the display device by laminating a first display panel and a second display panel. Since a second pixel unit is laminated from a middle position of a first pixel unit and gradually extends to an edge of the first pixel unit, the first display panel and the second display panel cannot be accurately laminated due to an accuracy problem of the laminating device. Hence, the first pixel unit is extended to a frame area and the second pixel unit is also partially extended to the frame area at the same time, and a normal display of a display area will not be affected even if the first pixel unit and the second pixel unit at an edge have misalignment, which can effectively prevent color deviation due to laminating misalignment caused by laminating the first pixel unit and the second pixel unit at the edge of the display area of the display device.

The descriptions of the above embodiments are only used to help understand the technology of the present application, solutions and their core ideas; those of ordinary skill in the art should understand that they can still modify the technical solutions described in the foregoing embodiments or equivalently replace some of the technical features, and these modifications or replacements do not make the essence of the corresponding technical solutions deviate from the scope of the technical solutions of the embodiments of the present application.

What is claimed is:

1. A display device having a display area and a frame area surrounding the display area, comprising:
a first display panel comprising a plurality of first pixel units arranged in an array, wherein the first pixel units are distributed in the display area and extend to the frame area, and the first pixel units at an edge of the display area extend to the frame area; and
a second display panel disposed above the first display panel, wherein the second display panel comprises a plurality of second pixel units arranged in an array, and the second pixel units correspond to the first pixel units.

2. The display device according to claim 1, wherein:
the first display panel comprises:
a first glass substrate disposed in the display area and the frame area;
a first liquid crystal layer disposed on the first glass substrate; and
a second glass substrate disposed on a side of the first pixel units away from the first liquid crystal layer;
and
the second display panel comprises:
a third glass substrate disposed on a side of the second glass substrate away from the first liquid crystal layer;
a second liquid crystal layer disposed on a side of the third glass substrate away from the first pixel units;
a color resist layer disposed on a side of the second liquid crystal layer away from the third glass substrate; and
a fourth glass substrate disposed on a side of the color resist layer away from the second liquid crystal layer.

3. The display device according to claim 2, further comprising a backlight disposed on a side of the first glass substrate away from the first liquid crystal layer.

4. The display device according to claim 2, wherein the first liquid crystal layer comprises:
a first polarizer disposed on the first glass substrate;
a first liquid crystal cell evenly disposed on a side of the first polarizer away from the first glass substrate; and
a first analyzer disposed on a side of the first liquid crystal cell away from the first polarizer.

5. The display device according to claim 4, wherein the second liquid crystal layer comprises:
a second polarizer disposed on the second glass substrate;
a second liquid crystal cell evenly disposed on a side of the second polarizer away from the second glass substrate; and
a second analyzer disposed on a side of the second liquid crystal cell away from the second polarizer,
wherein a light-transmitting axis-direction of the first polarizer is perpendicular to a light-transmitting axis-direction of the first analyzer, the light-transmitting axis-direction of the first analyzer is parallel with a light-transmitting axis-direction of the second polarizer, and the light-transmitting axis-direction of the second polarizer is perpendicular to a light-transmitting axis-direction of the second analyzer.

6. The display device according to claim 1, wherein a ratio of a width of the first pixel units extending out of the display area to a width of the first pixel units is 1.5:1.

7. The display device according to claim 1, further comprising:
a plurality of source driving chips disposed in the frame area; and
a plurality of electrode traces connecting the pixel units and the source driving chips, wherein the pixel units in a same column direction are connected to corresponding source driving chips through a same electrode trace.

8. The display device according to claim 7, wherein the source driving chips comprise a first source driving chip and a second source driving chip disposed on both sides of a circuit board, and a plurality of third source driving chips disposed between the first source driving chip and the second source driving chip;
the first source driving chip and the second source driving chip use 322 channels; and
the third source driving chips use 320 channels.

9. The display device according to claim 1, wherein a color of the second pixel units comprises at least one of red, blue, or green, and the second pixel units are arranged at an interval when the second pixel units comprise more than one color.

10. The display device according to claim 1, wherein a width of the first pixel units on an outermost side of the first display panel is half of a width of the first pixel units in the display area.
